(19) United States
(12) Patent Application Publication
(10) Pub. No.: US 2006/0089732 A1
(43) Pub. Date: Apr. 27, 2006

(54) Electrical household appliance equipped with a control device and a display device

(75) Inventor: Jurgen Range, Schlotheim (DE)

Correspondence Address: AKERMAN SENTERFITT, P.O. BOX 3188, WEST PALM BEACH, FL, 33402-3188, US

(73) Assignee: E.G.O. Control Systems GmbH & Co. KG, Balingen (DE)

(21) Appl. No.: 10/523,476

(22) PCT Filed: Sep. 9, 2002
(86) PCT No.: PCT/EP02/10082

§ 371 Date: Jul. 25, 2005

(30) Foreign Application Priority Data
Aug. 6, 2002 (DE) 102 36 718.3

(51) Int. Cl. G05B 11/01; G05B 15/00

(52) U.S. Cl. 700/83; 700/19; 700/20

(57) ABSTRACT

One embodiment of the invention concerns an electrical household apparatus, for example a washing machine, equipped with a control device in the form of a panel, said panel comprising a display device for providing visual data to the user. Said panel (10) is made of a material which is substantially opaque when it has a normal thickness (14). One area specific to the display device (15) comprises at least one transparency zone (20) wherein the thickness of the panel material is reduced relative to the thickness of the material outside said transparency zone such that light from a light source (16), for example a light-emitting diode, located behind the panel may pass through said transparency zone. Such a configuration provides backlighted panels having a closed surface. In another embodiment, the control device is in the form of a turning knob (70, 80).

### FIELD OF APPLICATION AND PRIOR ART

The invention relates to a domestic electrical appliance, particularly a washing machine, a clothes drying machine or a dishwasher, having at least one control device, with which is associated at least one display device for providing visual information to the user.

The casings of washing machines, dryers, dishwashers or other domestic electrical appliances having a comparable size are generally built up in a number of parts and are provided with panels on which are provided control elements and display devices to provide visual information to the user. Nowadays such panels are mainly made from high strength, impact-stable plastic by injection moulding processes. The control elements in the form of rotary knobs, switches, push buttons, contact surfaces or the like enable the user to operate the appliance manually. For displaying the state of the appliance and/or for displaying values, e.g. temperature values or the like, display devices are provided. Frequently multisegment displays, e.g. LCD displays are used for displaying values. Generally for displaying states use is made of LED displays, which are normally switched in such a way that they light up when a corresponding state is active. For the fitting of the LCD displays or the light emitting diodes shape-adapted through openings are made in the panel material either at the time of moulding or by subsequent mechanical machining.

Particularly for applications in damp rooms, such as e.g. in the case of washing machines or clothes drying machines, it is appropriate to seal off the area of the display devices used so that no moisture can pass through the panel into the electronic control device of the appliance normally positioned behind the panel. In addition, the panels offer little flexibility in variant formation, because for each equipping variant of a domestic electrical appliance, which is characterized by a specific number and specific types of display devices, specially adapted panels with a corresponding number of openings have to be kept in stock. The lack of flexibility in variant formation has a disadvantageous effect on the delivery dates which can be provided and the costs of the finished appliances.

### PROBLEM AND SOLUTION

The problem of the invention is to provide a domestic electrical appliance of the aforementioned type for whose manufacture there is a high flexibility in variant formation and which is characterized by operational reliability and an attractive design.

To solve this problem the invention provides a domestic electrical appliance having the features of claim 1. In addition, a control device or a panel for such a domestic electrical appliance having the features of claim 28 are provided. Advantageous further developments of the invention are given in further claims and are explained in greater detail hereinafter. By express reference the wording of all the claims is made into part of the content of the description.

In the case of the domestic electrical appliance of the aforementioned type according to the present invention, the control device at least partly comprises a covering material, which for the standard material thickness chosen for the control device surface is substantially opaque. In an area provided for the display device the control device has at least one transparency or transillumination area in which the covering material thickness is so reduced compared with the standard material thickness that the transillumination area is at least partly transilluminatable, at least zonally, by the light of a light source associated with the control device. When the light source is not operated, the transillumination area is to be opaque.

Numerous different control devices can be used and further reference will be made to these hereinafter.

Thus, control devices according to the invention do not have to have in the vicinity of the display device through holes for the introduction of light sources, displays, etc. According to the invention and in the case of a suitable choice of material for the control device it is possible to make it transparent in the transillumination area and otherwise in the vicinity of the transillumination area and in all areas not required for an optical display function to give it such a large wall thickness that the control device as a dimensionally stable component can take over a protective function for components positioned behind the control device.

The light source can be positioned facing the transillumination area on the back of the control device.

The covering material can be any suitable plastic, e.g. a suitable ABS plastic, such as is e.g. used in conventional panels for domestic appliances or in casings for other electrical appliances. In the case of plastic panels it is possible to introduce the transillumination area into the component during the manufacturing process by a corresponding shaping of the injection mould, so that no mechanical reworking is necessary. However, it is also possible to subsequently introduce transillumination areas, e.g. by material-abrading machining, into the conventionally manufactured control device.

Normally the standard material thickness is in the range above 1 mm and is in particular at least 2 mm. These material thicknesses are sufficient even in the case of flat spread-out control devices or e.g. panels to ensure an adequate stability. However, in the transillumination area the material thickness should at least zonally be less than 0.8 mm and is in particular between approximately 0.3 and approximately 0.5 mm. It has been found that e.g. in the case of ABS plastics, material thicknesses of approximately 0.3 to 0.4 mm are adequately transparent for the light of standard light sources provided with a normal luminosity to enable a clear distinction between switched on and off light sources, even in bright rooms.

The invention makes it possible to create control devices, whose front surface facing the user is closed in the vicinity of the display device, i.e. uninterrupted or continuous. As opposed to conventional control devices there are no openings, slits or the like through which it would e.g. be possible for moisture and/or contaminants to penetrate. Normally the front surface is smooth throughout and can be easily cleaned. In many embodiments the situation is such that on the front of the panel in the vicinity of the transillumination area and/or in the transillumination area a preferably permanent marking is applied and e.g. by means of a suitable symbol makes clear the function associated with the corresponding light source. This can e.g. be a matter of printed on or laser machining-produced symbols, numbers, letters and/or the like.

The effect obtained through the invention, namely the creation of zonally transparent or partly transparent areas in a control device closed to the outside and having a continuous, gap-free surface could also be obtainable if during the manufacture of a control device, in the vicinity of the display device, small “windows” of a plastic were provided which is more transparent for the light of the light source than the plastic used for the remaining parts of the panel. The use of a single covering material for thick and thin areas is, however, much more cost-effective.

The invention makes it possible to use the same control device with a fixed predetermined number of transillumination areas for all the appliances of a series, which can be characterized by numerous different equipping variants. Said number of transillumination areas should correspond to the maximum possible number of states to be displayed and/or display devices. If in a simpler equipping variant one or other function is not provided, the corresponding transillumination area does not have to be used. It is not then detectable in the external appearance of the panel, because without back-lighting the transillumination areas cannot normally be distinguished from the opaque areas surrounding them.

In simple variants, the transillumination area can essentially be characterized by a recess introduced into the covering material from the rear and in whose vicinity the material thickness is brought to a level which can be transilluminated. In many embodiments the situation is such that the back of the control device facing or which can be made to face the light source is provided in the transillumination area with a macroscopic surface structuring. This can e.g. be a scattering structure, which contributes to a uniform illumination of a more extensive transillumination area, even if only a single, small area light source is used.

A macroscopic surface structuring can have a plurality of grooves and raised portions and these are then dimensioned in such a way that at least in partial areas of the grooves the covering material is sufficiently thin for it to be transilluminatable. In the case of a surface structure with grooves or channels corresponding to reduced material thickness areas, as well as thicker webs or raised portions, the latter can pass from one edge to the other of the transillumination area. In this way they contribute to a mechanical stabilization of the transillumination area. In this case a double function can be fulfilled by the macroscopic surface structuring. The cross-sectional shape of the grooves can e.g. be V-shaped, U-shaped, trapezoidal or rectangular and the grooves can be linear or curved. For example it is possible to have structures with parallel channels in one direction or with crossed channels, e.g. in two directions perpendicular to one another. In this case e.g. with V-shaped or trapezoidal grooves the intermediate, raised portions can be pyramidal and optionally form a light-scattering structure. Structures with concentric circles are also conceivable. In all structures uniform or non-uniform spacings between individual channels or the like are possible.

In or on the transillumination area can be provided additional light-varying or light-conducting devices, which can also comprise separate parts. It is possible to have coloured devices or to colour the latter, so-called colour wheels or colour filters being suitable.

Advantageously at least one light-varying or light-conducting device from among the following group is provided: light guides, light distributors, light deflectors, concentrators, lenses and prisms. Obviously also several functionalities can be formed in a single device. In the case of light-conducting elements the light source can be positioned further from the transillumination area.

The light-varying or light-conducting device can be fixed or detachable with respect to the control device close to or directly at the transillumination area. It is either possible to use bonding or moulding in or round. Moulding in advantageously takes place in a multicomponent process.

The light-varying or light-conducting device can also be detachably fixed to the control device, preference being given e.g. to screw, clip or click-stop connections.

It is possible to provide in the transillumination area at least one recess in the form of a multisegment display, e.g. in the form of a seven-segment display. A separately controllable light source can be associated with each of the segments in order to light up the corresponding channel in targeted manner. On the back of the control device it is optionally possible to provide between the individual channels corresponding to the segments shielding webs or the like, which are shaped onto the control device to prevent the swamping out of light sources in non-associated segmental portions.

Display devices according to the invention can be extensively provided separately or in a spatial association with other control elements, such as mechanical push buttons, rotary knobs, sliders and the like. In preferred embodiments there is an integration of a display device with an associated control element. As a result a combined display and control element can be created. In particular it is possible to associate with the transillumination area a sensor device for generating a switching signal and which comprises at least one sensor element, which in the case of the approach of a finger or the like and/or on contact with a finger tip or the like responds so as in this way to initiate the generation of a switching signal (approach or contact sensor). The control element can e.g. be constructed as a capacitive control panel with a sandwich structure, as disclosed in German utility model DE 201 19 700.6. The relevant disclosure of the latter is by express reference made into part of the content of the present application.

As stated hereinbefore, such a control device can e.g. be a panel, but also a movable control device in the form of a rotary or sliding toggle or a push button. A movable control device can be fitted to a panel or one side, advantageously the front side, of the domestic electrical appliance. On the one hand a light source can at least partly project into said movable control device and is preferably located therein. On the other hand the light source can be located in the domestic electrical appliance outside the control device. For example, a light-conducting duct can lead from the light source to the transillumination area and the light-conducting duct is in particular a light guide.

The invention also relates to a control device or a panel of the described type having at least one transillumination area. Such control devices or panels offer maximum flexibility in representation and colouring of the appliance control front, which is formed or impressed by the panel front surface facing the user. Inventive panels are easy to manufacture and install. In simple manner they permit the introduction of light-conducting and/or illumination-permitting devices in the plastic injection moulding material, e.g. scattering structures or the like. The reliability of the electrical appliances equipped with panels according to the invention increases, because a penetration of moisture and contaminants in the vicinity of the panel is reliably prevented.

The above and further features can be gathered from the claims, and the description relative to the drawings and the individual features, both singly or in random combinations, can be implemented in an embodiment of the invention and in other fields and can represent advantageous, independently protectable constructions.

### BRIEF DESCRIPTION OF THE DRAWINGS

Embodiments of the invention are shown diagrammatically in the drawing and explained in greater detail hereinafter.

FIG. 1 is a diagrammatic section through the area of a panel of an embodiment of the invention, where behind the panel is provided a printed circuit board with a light emitting diode as the light source.

FIG. 2(a)-(c) diagrammatically show different embodiments of transillumination areas, whose back has a macroscopic surface structuring.

FIG. 3 shows a perspective sectional view through a transillumination area with recesses in the form of a seven-segment display.

FIG. 4 shows a variant of the panel of FIG. 1 in a simplified representation with moulded in light guide.

FIG. 5 shows a diagrammatic section through a rotary toggle with transillumination area and projecting in light guide, a point on the front face of the rotary toggle being illuminated in each rotation position.

FIG. 6 shows a diagrammatic section through a rotary toggle similar to FIG. 5 with transillumination area and projecting in light guide, a point on the side of the rotary toggle being illuminated only in a single rotation position.

### DETAILED DESCRIPTION OF THE EMBODIMENTS

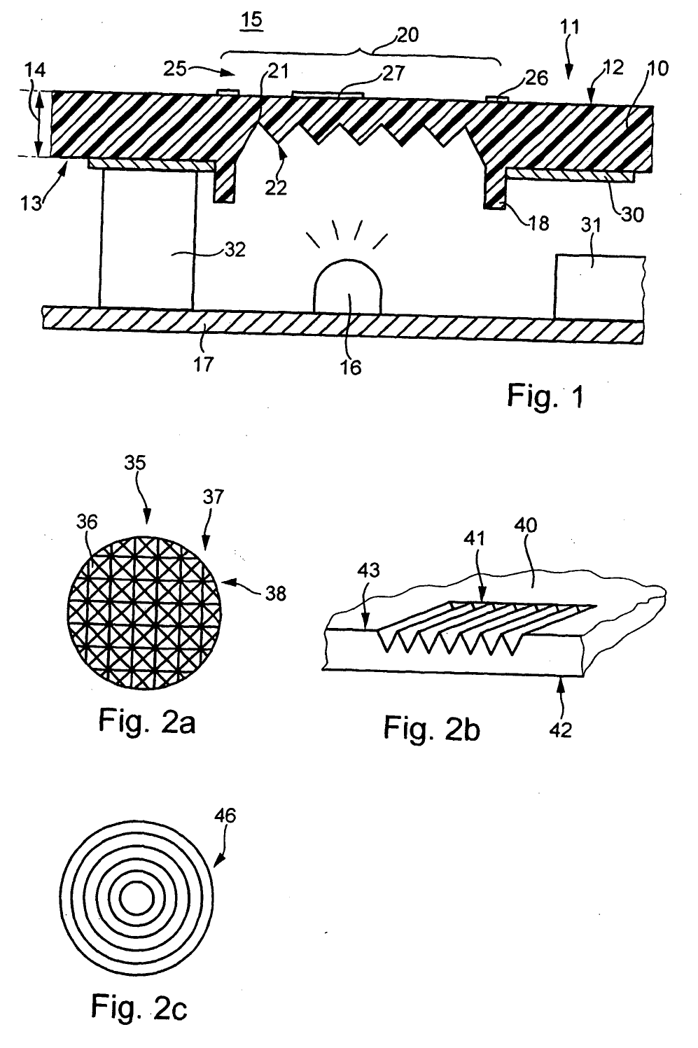

The diagrammatic representation of FIG. 1 is a section through the front of a clothes dryer in the vicinity of a panel 10 facing the user. The panel 10 is an integral plastics moulding, which in the present embodiment is made from ABS plastic. The dimensionally stable component has a front side 11 facing the user and which is provided with a smooth, glossy, closed surface 12. At most points of the panel the standard material thickness of said panel 10, i.e. the distance between the front surface 12 and rear surface 13, is approximately 2.6 mm. With such a material thickness the panel material ABS is opaque for visible light, so that components of the appliance, particularly components of an electronic control located behind the panel are not visible from the front. With such a material thickness the panel material is torsionally strong, so that the entire panel as a separate component is self-supporting and on installing the appliance can be fitted simply thereto, e.g. by using screws.

With the panel is associated a display device 15 for optical user information. This display device comprises a light source 16 constructed as a light emitting diode and which is fitted to a printed circuit board 17, which is connected to the panel by not shown fastening elements. In the area provided for the display device the panel 10 has a circular transillumination area 20, where the panel material thickness is reduced compared with the standard material thickness 14 in such a way that the transillumination area is at least in parts of its surface transilluminatable by the light of the light source 16 positioned facing the panel back 13. The transillumination area 20 is substantially formed by a reduced material thickness area in the panel 10. It is surrounded by a circumferential web 18 projecting towards the light source 16.

In this embodiment, during the manufacture of the panel 10 by injection moulding, through suitable shaping of the mould a roughly circular recess was formed on whose base facing the front side 11 is formed a macroscopic structure in the form of channels 21 and intermediate raised portions 22. The channels and raised portions have in each case a triangular cross-section. In the vicinity of the apex of the raised portions 22 facing the light source the material thickness is approximately 0.4 mm, whereas in the vicinity of the bottoms of the channels 21 facing the surface 12 it is only approximately 0.3 mm. These material thicknesses are so matched to the optical characteristics of the ABS plastic used that the light of the light emitting diode 16 is weak in the vicinity of the raised portions 22 and strong in the vicinity of the channels 21 and from the outside in clearly visible manner transilluminates the panel material in the transillumination area 20, so that from the front 11 it is possible for a user to see through the panel whether the light emitting diode 16 is switched on or off. Therefore the reduced material thickness transillumination 20 has the function of an opal glass window constructed integrally with the surrounding panel material and whose structured surface facing the light source 16 produces a certain scattering action, so that it permits independently of the shape of the light source 16 a relatively uniform illumination of the entire transillumination area 20. Optionally an optically attractive banded structure can be detected within the illuminated area.

The light emitting diode 16 serves as an optical state display for a function of the clothes dryer, which can e.g. be configured in such a way that the diode 16 lights up on switching an anti-creasing function or a storage dry function. An identically or analogously constructed display can e.g. also be provided for the start/stop function. Other operating modes can also be displayed in the indicated manner. In order to permit for the user a clear association between the lighting up of a transillumination area 20 and an associated function of the appliance, on the front surface 12 of the panel 10 a marking 25 is applied by printing on. It comprises a closed ring 26 surrounding the transillumination area, as well as a symbol 27, within the ring 26, characterizing the corresponding function.

This embodiment of the domestic electrical appliance is characterized by maximum operating comfort and this is assisted by the fact that in this embodiment the display device is combined in a sandwich structure with a capacitive operating device. The function indicated by the marking 25 can be switched on or off by the user by operating a capacitive sensor device. The sensor device comprises a sensor element 30 fitted to the back 13 of the panel 10 and which surrounds in annular manner the transillumination area 20 outside the web 18, as well as a control 31 on the printed circuit board 17. A possible construction of such a sensor element as well as its function are represented e.g. in EP 859 468, whose content is by reference made into part of the content of the present application. A corresponding description also appears in the applicant's DE 201 19 700.6, whose content is also made by reference into part of the content of the present description. Typically the size of such a sensor element is roughly the same as a finger tip, e.g. it can have a side edge length or diameter between approximately 10 mm and approximately 25 mm.

An elongated, pin-shaped contact part 32 extends from the printed circuit board 17 with the control 31, to which it is electrically conductively connected by means of a flat contact, to a contact bank of the sensor element 30. In this way the sensor element 30 is electrically conductively connected to the control 31 or printed circuit board 17. The contact part can have an elastic construction, e.g. in the form of a metallic helical spring or compressible element of conductive, elastic plastic.

The sensor element 30 is applied with the aid of a printing process, e.g. a suitable screen printing process, directly to the back 13 of the panel 10. As an alternative to the use of a screen printing process with an electrically conductive material for the sensor element 30, it is also possible to apply a metal foil-like part or platelet by bonding or in some other to the panel back 13. Metallized or metallic adhesive foils can also be used as sensor elements 30.

If a user now brings her finger into the vicinity of or on the area indicated by the marking 25, in an electric circuit surrounding the sensor element a capacitance change occurs and is further processed by the control 31 for generating a switching signal. Simultaneously with the switching on or off of the corresponding function, the light emitting diode 16 is switched on or off.

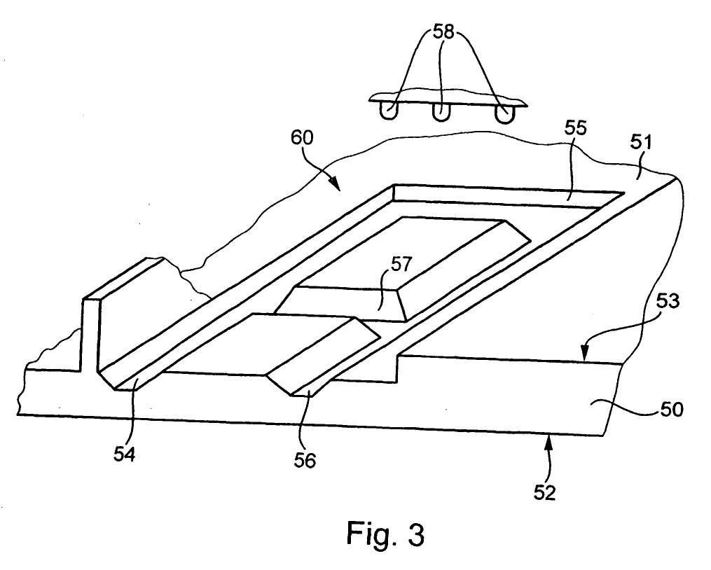

Alternative shapes and structures of transillumination areas are shown in FIGS. 2 and 3. FIG. 2(a) shows a circular transillumination area 35, where the low material thickness zone on the side to face the light source has a pyramidal structure with a plurality of directly adjacent quadrangular pyramids 36. If the light source side of the transillumination area is produced by material abrasion, it is possible to produce the pyramidal structure in that in directs 37, 38 perpendicular to one another are produced in directly juxtaposed manner channels having a V-shaped cross-section. If the structure is produced during injection moulding, for this purpose the corresponding part of the mould can have a circular area with a corresponding honeycomb structure. The pyramidal structure has a scattering effect, so that independently of the shape of the light source, the transillumination area appears substantially uniformly illuminated from the user side.

The panel 40 shown in detail form in FIG. 2(b) has a rectangular transillumination area 41 formed by parallel V-shaped grooves and raised portions. The panel material thickness in the vicinity of the channel bottoms facing the front surface 42 of approximately 0.3 to 0.4 mm is sufficiently thin for there to be an adequate transparency here. In the vicinity of the tips of the raised portions on the back 43, the material thickness of approximately 0.5 to 0.7 mm makes the material largely opaque. Therefore when the light source is switched on, the transillumination area 41 has a banded pattern.

FIG. 2(c) shows in exemplified manner a panel having a circular transillumination area 46, where there are macroscopic surface structures in the form of concentric circles, which can e.g. be formed by rectangular or V-grooves.

The hitherto shown examples of transillumination areas are preferably usable in conjunction with simple light sources in order to indicate the switching state of a function (on or off). In many appliances it is also desirable to display for an operating mode or an additional function associated values such as e.g. presetting times, remaining running times, degrees of moisture, temperatures, etc. In conventional appliances for this purpose use is frequently made of multisegment displays, e.g. LCD or LED seven segment displays. A corresponding functionality can be provided when using the present invention.

To this end FIG. 3 diagrammatically shows a panel 50 having in its thickest areas a material thickness of approximately 2.6 mm. In a rectangular area 51 provided for a display device the material thickness is reduced to approximately 1 mm. Within this area there is a further wall thickness reduction in order to create a transillumination area 60 in the form of a seven segment display. For this purpose channels 54 to 57 with a trapezoidal cross-section are formed on the bottom of the rectangular area, i.e. on the back 53 facing the front 52. Overall the channels form a configuration shaped like a rectangular eight and can in the same way as a seven segment display be considered as broken down into seven functionally separated partial channels or channel segments. With each of the channel segments is associated a group of light sources. For example, a row of three light emitting diodes 58 is shown, which are positioned a limited distance behind the back 53 in the vicinity of the cross-channel 55 at the top. If these light sources 58 light up, the emitted light essentially only occurs in the cross-channel 55, which then lights up for the user on front 52. In order to prevent a swamping out of the light in other segments, they can be shielded by suitable, not shown shields with respect to the light of light sources 58. It is also e.g. possible to provide for the central cross-channel 57 a not shown row of three light emitting diodes. On the longitudinal channels 54, 56, which are in each case broken down into two partial channels, running perpendicular thereto are provided in each case two independently controllable groups of in each case three light emitting diodes which illuminate said partial channels.

Through a suitable control of the light sources associated with the channel segments, it is possible in the manner of a seven segment display to symbolize with the latter any random number and any random letter. Normally a display device has several such seven segment transillumination areas in juxtaposed form, e.g. four such areas, in order to display clock times or time intervals, as well as optionally temperatures and the like.

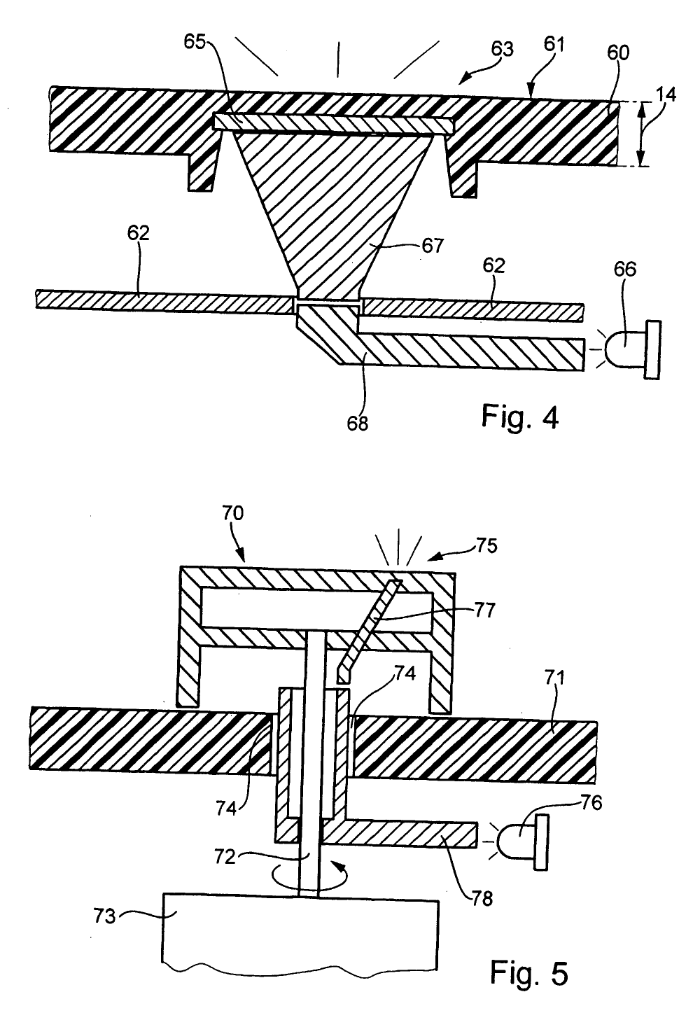

FIG. 4 shows a greatly simplified variant of the panel 10 shown in FIG. 1. The panel 60 shown in FIG. 4 has a smooth front side 61. Obviously, in accordance with FIG. 1, symbols or the like could be applied here. The panel 60 has a normal material thickness 14, e.g. corresponding to that of FIG. 1. However, the transillumination area 63 is made thinner, as in FIG. 1, but does not have a structure. For this purpose a so-called light distributing plate 65 is provided and is, as is clearly shown in FIG. 4, embedded in the material of the panel 60.

The embedding of the light distributing plate 65 in the panel 60 can take place in numerous different ways, as described hereinbefore. In FIG. 4 it is moulded in, using a so-called two-component process. The latter is known per se and consequently does not have to be described here. In this way the light distributing plate 65, which can be made from a transparent plastic, e.g. an acrylic material, is embedded in fixed, non-detachable and non-movable form.

Instead of being moulded in a light distributing plate 65 could also be clipped in. This would be possible if the back-engagement in FIG. 4 was reduced. With regards to the manufacturing costs of the panel, clipping in is less expensive, but an installation process is required.

A first light guide 67 is positioned behind the light distributing plate 65. Light from a light emitting diode 66 is coupled into the light distributing plate 65 by means of a second light guide 68 and also the first light guide 67. This is readily apparent to the expert from the drawing in conjunction with the above description and consequently requires no explanation here.

As is intimated in FIG. 4, the first and second light guides 67, 68 can be fixed to the printed circuit board 62, e.g. by clamping or bonding in.

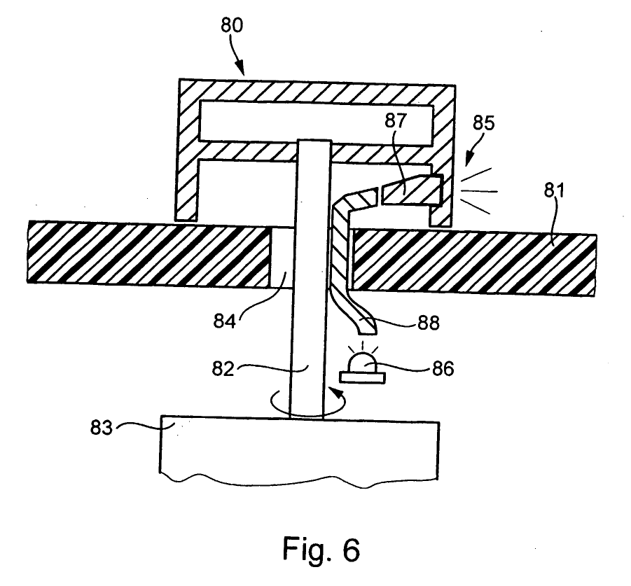

Once again much as in FIG. 1, on the panel 60 can be provided actuating devices, e.g. sensor elements, in the area surrounding the transillumination area 63. They are not shown for reasons of simplicity.

Whereas in the preceding drawings fixed or immovable control devices in the form of a panel are shown, FIGS. 5 and 6 show movable control devices, namely rotary toggles. FIG. 5 shows a rotary toggle 70, which is located on the front of a standard panel 71, which can e.g. be a glass ceramic hotplate. It is located on a rotary spindle 72, which is connected to a switching device 73 positioned behind the panel 71. By rotating the rotary toggle 70 an actuation takes place on the switching device 73.

A LED 76 is located behind the panel 71 and emits light into a second light guide 78. As can be seen in FIG. 5, the light guide 78 projects through the through opening 74 in panel 71. In this area the second light guide 78 is circumferential, i.e. roughly cup-shaped.

A first light guide 77 is connected in light-conducting manner to the second light guide 78 and has a limited spacing therefrom. As can be seen, the first light guide 77 is enclosed in the rotary toggle 70. By its front end the light guide 77 projects into a transillumination area 75 on the front surface of the rotary toggle 70. In the transillumination area 75 the material thickness of the front side is, according to the invention, much less than the otherwise provided standard material thickness.

As a result of the circumferential construction of the second light guide 78 above the panel 71, light is given off continuously in each rotation position. However, the first light guide 77 has a rod-shaped construction. In each rotation position it can take light from the second light guide 78 and deliver it in substantially punctiform manner in transillumination area 75. The first light guide 77 is fixed in the rotary toggle 70 advantageously by sticking in with press fit or bonding in.

FIG. 6 shows a further rotary toggle 80 constituting a variant of the rotary toggle 70 in FIG. 5. By means of a through opening 84 in panel 81 the rotary toggle 80 is connected via rotary spindle 82 to the switching device 83.

Here a LED 86 is connected to a second light guide 88, which projects e.g. in rod-like manner through the through opening 84 into the interior of the rotary toggle 80. Unlike in FIG. 5, the second light guide here is not constructed in a cup-shaped or circumferential manner.

The second light guide 88 is connected to a first light guide 87 and couples light into the latter. Towards the side of the rotary toggle 80, the first light guide 87 is aligned with a lateral transillumination area 85. In said transillumination area 85 once again the material thickness is reduced compared with the remaining standard material thickness in such a way that according to the invention the material is transparent and the transmitted light of the LED 86 is emitted, as shown, to the outside.

This variant of a rotary toggle 80 consequently brings about an emission of a light signal or the like in a single rotary position of the rotary toggle 80. This is precisely the position in which the first light guide 87 by rotation coincides precisely with the first light guide 88 fixed to the panel 81.

Numerous standpoints are involved in deciding for which particular use a rotary toggle 70 according to FIG. 5 or a rotary toggle 80 according to FIG. 6 is employed and there is no need to discuss this matter here.

It is once again pointed out that the drawings are only to be understood diagrammatically, this particularly applying with regards to the sizes or thicknesses or the relative sizes.

The invention illustrated in exemplified manner by embodiments can be used in order to provide randomly designed display devices for use in electrical or electrically controlled installations, apparatus or appliances and more particularly in domestic appliances. Preferred fields of use are large domestic appliances, e.g. washing machines, dryers or dishwashers, which are conventionally provided with through, non-transparent plastic panels or control devices in the form of rotary toggles or the like. If they are modified in accordance with the invention inexpensive possibilities are provided for ensuring maximum flexibility with respect to the variant formation of the display devices. As a result of the invention it is possible for a single type of panel with prepared transillumination areas to be used for an entire appliance family with the most varied functionality finishes and then, as a function of the appliance finish or equipment, can be combined with suitable lighting devices. Since the invention leads to panels with displays and closed surfaces, a maximum of operational reliability accompanied by an extremely pleasing appearance is made possible.

1. Domestic electrical appliance, particularly washing machine, clothes drying machine or dishwasher, having at least one control device (10, 40, 50, 60, 70, 80), with which is associated at least one display device (15) with a light source (16, 66, 76, 86) for providing visual information to the user, the control device at least partly comprising a covering material which for a standard material thickness (14) is substantially opaque and in an area provided for the display device has at least one transillumination area (20, 35, 41, 46, 60, 63, 75, 85) in which the material thickness of the covering material is so reduced compared with the standard material thickness that the transillumination area can be transilluminated by the light of the light source (16).

2. Domestic electrical appliance according to claim 1, characterized in that the light source (16, 66, 76, 86) is positioned at the back of the control device (10, 40, 50, 60, 70, 80) facing the transillumination area (20, 35, 41, 46, 60, 63, 75, 85).

3. Domestic electrical appliance according to claim 1 or 2, characterized in that the covering material is a plastic, particularly an ABS plastic.

4. Domestic electrical appliance according to one of the preceding claims, characterized in that the transillumination area (20, 35, 41, 46, 60, 63, 75, 85) of the control device (10, 40, 50, 60, 70, 80) is produced by injection moulding during the manufacture of the control device.

5. Domestic electrical appliance according to one of the preceding claims, characterized in that the standard material thickness (14) exceeds approximately 1 mm and is in particular at least 2 mm.

6. Domestic electrical appliance according to one of the preceding claims, characterized in that the material thickness in the transillumination area (20, 35, 41, 46, 60, 63, 75, 85) is at least zonally less than approximately 0.8 mm, particularly less than approximately 0.5 mm and preferably between approximately less than approximately 0.5 mm and preferably between approximately 0.3 mm and approximately 0.5 mm.

7. Domestic electrical appliance according to one of the preceding claims, characterized in that a user-facing front surface (12) of the control device is closed and/or substantially smooth in the vicinity of the display device (15).

8. Domestic electrical appliance according to one of the preceding claims, characterized in that a user-facing front surface (12) of the control device has in the vicinity of and/or in the transillumination area a preferably permanently visible marking (25) for a functionality associated with the light source.

9. Domestic electrical appliance according to claim 2, characterized in that the control device back (13, 43, 53) facing or which can be made to face the light source has a macroscopic surface structuring in the transillumination area (20).

10. Domestic electrical appliance according to claim 9, characterized in that the surface structuring is constructed as a structure scattering the light of the light source (16).

11. Domestic electrical appliance according to claim 9 or 10, characterized in that the surface structure has a plurality of grooves (21) and raised portions (22) and the covering material is at least zonally transilluminatable, at least in the vicinity of the grooves.

12. Domestic electrical appliance according to one of the preceding claims, characterized in that additional light-varying or light-conducting devices are located in the transillumination area (20, 35, 41, 46, 60, 63, 75, 85) and comprise separate parts.

13. Domestic electrical appliance according to claim 12, characterized in that the devices are coloured and are in particular colour wheels.

14. Domestic electrical appliance according to claim 12 or 13, characterized by at least one device from the following group: light guides, light distributors, light deflectors, concentrators, lenses and prisms and preferably in the case of light-conducting elements the light source (16) can also be further removed from the transillumination area (20, 35, 41, 46, 60, 63, 75, 85).

15. Domestic electrical appliance according to one of the claims 12 to 14, characterized in that the light-varying or light-conducting device (65) is connected in fixed, non-detachable manner with the control device close to or directly at the transillumination area (63) and is in particular moulded in using a multicomponent process.

16. Domestic electrical appliance according to one of the claims 12 to 14, characterized in that the light-varying or light-conducting device (77) is detachably fixed, preferably screwed or clipped, to the control device.

17. Domestic electrical appliance according to one of the preceding claims, characterized in that in the transillumination area (60) the control device (50) has at least one recess in the form of a multisegment display, particularly in the form of a seven segment display.

18. Domestic electrical appliance according to one of the preceding claims, characterized in that the light source has at least one light emitting diode (16, 66, 76, 86).

19. Domestic electrical appliance according to one of the preceding claims, characterized in that with the transillumination area (20) is associated an actuating device (30, 32) for actuating a function or functional device of the domestic electrical appliance and preferably the actuating device has no movable parts.

20. Domestic electrical appliance according to claim 19, characterized in that the actuating device has a sensor device (30, 32) for generating switching signals as a reaction to an approach or contact of an area surrounding the transillumination area and preferably the sensor device is constructed as a capacitive sensor device.

21. Domestic electrical appliance according to claim 19 or 20, characterized in that the actuating device has at least one sensor element (30) fitted to the control device back and which at least zonally surrounds the transillumination area (20).

22. Domestic electrical appliance according to one of the preceding claims, characterized in that the control device is a panel (10), which is in particular placed in fixed manner on the domestic electrical appliance, the covering material being the panel material and for control purposes there are further actuating devices such as sensor devices (30, 32) or the like.

23. Domestic electrical appliance according to one of the claims 1 to 21, characterized in that the control device (79, 80) is movable and is located on one side of the domestic electrical appliance, e.g. a panel (71, 81), the control or operation of the domestic electrical appliance being determined by the direction and/or extent of the movement.

24. Domestic electrical appliance according to claim 23, characterized in that the control device is a toggle (70, 80) with a movement direction in a plane parallel to the side of the domestic electrical appliance, preferably being a rotary toggle.

25. Domestic electrical appliance according to claim 23, characterized in that the control device is a button with a movement direction into the side of the domestic electrical appliance and is preferably a push button.

26. Domestic electrical appliance according to one of the preceding claims, characterized in that the light source (16, 66, 76, 86) at least partly projects into the control device and is preferably located therein.

27. Domestic electrical appliance according to one of the claims 1 to 25, characterized in that the light source (16, 66, 76, 86) is located in the domestic electrical appliance outside the control device and preferably with a light-conducting duct from the light source to the transillumination area and in particular the light-conducting duct is a light guide.

28. Control device, particularly panel (10, 40, 50) for fixing to an electrical appliance, particularly to a washing machine, a clothes drying machine or a dishwasher, the control device at least partly comprising a covering material which at the standard material thickness (14) selected for the control device is substantially opaque and in an area provided for a display device for providing the user with visual information has at least one transillumination area (20, 35, 41, 46, 60), in which the covering material thickness is so reduced compared with the standard material thickness that the transillumination area can at least zonally be transilluminated by the light of a light source positioned facing the back of the control device.

29. Control device according to claim 28, characterized by the features of the characterizing part of at least one of the claims 2 to 27.
